(19) United States
(12) Patent Application Publication
(10) Pub. No.: US 2024/0063642 A1
(43) Pub. Date: Feb. 22, 2024

(54) DYNAMIC PARALLEL TO SERIES CONTROLLER

(71) Applicant: HHeLi, LLC, Tulsa, OK (US)

(72) Inventors: Mike Render, Tulsa, OK (US); Peter Bontorno, Tulsa, OK (US)

(21) Appl. No.: 18/234,779

(22) Filed: Aug. 16, 2023

Related U.S. Application Data
(60) Provisional application No. 63/398,440, filed on Aug. 16, 2022.

(51) Int. Cl. H02J 7/00; H01M 10/48; H01M 10/44; H01M 10/42

(52) U.S. Cl. CPC H02J 7/0024; H02J 7/0047; H02J 7/007182; H01M 10/482; H01M 10/441; H01M 10/4257; H01M 2010/4271

(57) ABSTRACT

A battery pack, and a method and system for controlling the voltage across the battery pack. The battery pack may have a plurality of individual battery modules controlled by one or more switching units and one or more controllers. The switching units may electrically connect one or more battery modules in parallel to form one or more strings, which are connected in series.

### CROSS-REFERENCE TO RELATED CASES

This application claims the benefit of U.S. provisional patent application Ser. No. 63/398,440, filed on Aug. 16, 2022, and incorporates such provisional application by reference into this disclosure as if fully set out at this point.

### FIELD OF THE INVENTION

This disclosure relates to battery applications, specifically systems and methods for managing battery charging and discharging.

### BACKGROUND OF THE INVENTION

Battery capacity remains an ongoing area for improvement as portable batteries are used in more and various applications. Certain newer battery chemistries provide marked increases in capacity versus older lithium-based batteries. However, these newer chemistries present new challenges. Whereas older battery chemistries can provide a relatively constant voltage until they are near depleted, some newer chemistries may decrease markedly in voltage as they are discharged, giving them a sloped discharge curve. Accordingly, the voltage of these newer chemistries may drop below a useful level prematurely, while they have significant capacity remaining.

What is needed is a battery pack, a management system, and a method for using the remaining capacity in a battery after its voltage has depleted.

### SUMMARY OF THE INVENTION

The invention of the present disclosure, in one aspect thereof, comprises a battery pack. The battery pack comprises a plurality of battery modules, at least one switching unit adapted to determine a configuration of the battery modules, wherein the switching unit electrically connects one or more battery modules in parallel to form one or more strings, the strings being electrically connected in series. The battery pack also comprises an instrument adapted to measure a voltage across the battery pack. The battery pack further comprises at least one controller adapted to control the at least one switching unit in response to a voltage measurement from the instrument.

In some embodiments, as the battery modules discharge, the at least one controller and the at least one switching unit execute stepwise changes to the configuration of the battery modules to maintain the voltage across the battery pack above a predetermined lower threshold voltage. In some embodiments, as the battery modules charge, the at least one controller and the at least one switching unit execute stepwise changes to the configuration of the battery modules to maintain the voltage across the battery pack below a predetermined upper threshold voltage. As the battery modules discharge, each stepwise change to the configuration of the battery modules may double the number of strings electrically connected in series. As the battery modules charge, each stepwise change to the configuration of the battery modules may divide by two the number of strings electrically connected in series.

The invention of the present disclosure, in another aspect thereof, comprises a battery management system comprising at least one switching unit adapted to determine a configuration of a plurality of battery modules, wherein one or more battery modules are electrically connected in parallel to form one or more strings, the strings being electrically connected in series. The system also comprises an instrument adapted to measure a voltage across the battery modules. The system has at least one controller adapted to activate or deactivate the at least one switch in response to a voltage measurement from the instrument.

In some embodiments, as the battery modules discharge, the at least one controller and the at least one switching unit may execute stepwise changes to the configuration of the battery modules to maintain the voltage across the battery pack above a predetermined lower threshold voltage. As the battery modules discharge, each stepwise change to the configuration of the battery modules may double the number of strings electrically connected in series.

In some embodiments, as the battery modules charge, the at least one controller and the at least one switching unit may execute stepwise changes to the configuration of the battery modules to maintain the voltage across the battery pack below a predetermined upper threshold voltage. As the battery modules charge, each stepwise change to the configuration of the battery modules may divide by two the number of strings electrically connected in series.

The invention of the present disclosure, in another aspect thereof, comprises a method for managing the voltage across a plurality of battery modules, the method comprising the steps of obtaining a voltage reading from an instrument adapted to measure a voltage across a plurality of battery modules; comparing the voltage reading to a predetermined lower threshold voltage; and, using at least one controller and at least one switching unit, determining an electrical configuration of the battery modules, wherein one or more battery modules are electrically connected in parallel to form one or more strings, the strings being electrically connected in series.

In some embodiments, as the battery modules discharge, the at least one controller and the at least one switching unit may execute stepwise changes to the configuration of the battery modules to maintain the voltage across the plurality of battery modules above a predetermined lower threshold voltage. Each stepwise change to the configuration of the battery modules may double the number of strings electrically connected in series.

In some embodiments, the method further comprises the step of comparing the voltage reading to a predetermined upper threshold voltage. As the battery modules charge, the at least one controller and the at least one switching unit may execute stepwise changes to the configuration of the battery modules to maintain the voltage across the plurality of battery modules below a predetermined upper threshold voltage. Each stepwise change to the configuration of the battery modules may divide by two the number of strings electrically connected in series.

### BRIEF DESCRIPTION OF THE DRAWINGS

FIG. 1 is a generalized schematic of a battery pack and battery management system.

FIG. 2 is a perspective view of a battery pack.

FIG. 3 is a discharge curve for a battery with a sloped discharge curve.

FIG. 4 is a logic diagram for an embodiment of the system of this disclosure.

FIG. 5 is a schematic of a 4-battery pack according to this disclosure.

FIG. 6 is a table describing a capacity discharge of a simulated embodiment of a 4-battery pack with a battery management system.

FIG. 7 is a table describing a charge of the battery pack of FIG. 6.

FIG. 8 is a discharge curve of the battery pack of FIG. 6.

FIG. 9 is a simplified graph of a voltage output of a flat or plateaued discharge curve versus a sloped or steady discharge curve.

### DETAILED DESCRIPTION OF THE PREFERRED EMBODIMENTS

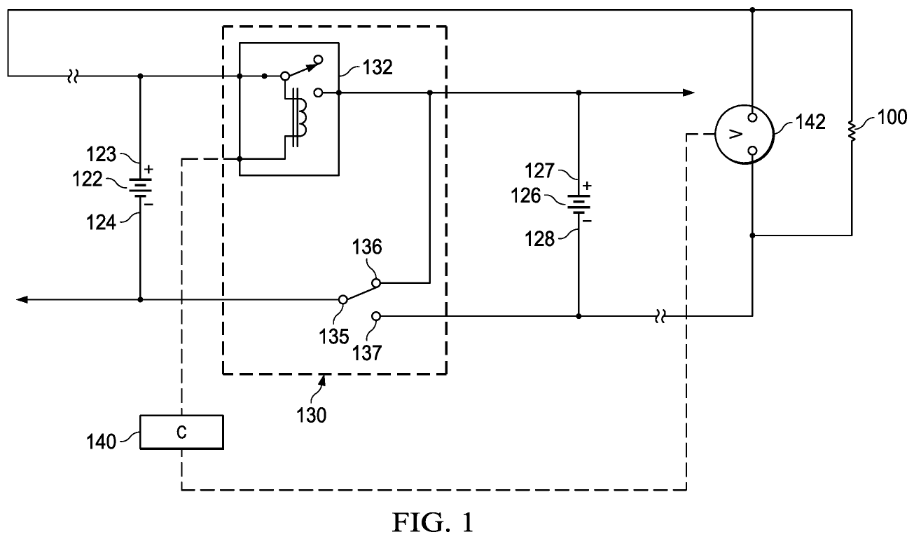

Referring now to FIG. 1, a generalized schematic of a battery pack and battery management system is shown. In some embodiments, a system of the present disclosure controls and manages a voltage output across a battery pack 102 as it charges or discharges across a load 100. The battery pack 102 has two or more battery modules 110. A battery module 110 may be a single electrochemical cell, multiple cells in electrical communication with one another and packaged within a single housing (i.e., a battery), or a combination of batteries. Battery modules 110 in the pack 102 may be linked to one another in a sequence through switching units 130. A switching unit 130 is any device that can be automatically operated to open or close a circuit. Insulated Gate Bipolar Transistors (IGBTs) may be used as switching units 130. In the embodiment of FIG. 1, the switching unit 130 is represented as a relay-switch module (“RSM”) with a single-pole-single-throw relay 132 and a single-pole-double-throw (SPDT) switch 134 with a common contact 135, a normally closed contact 136, and a normally open contact 137. Each switching unit 130 may have a predecessor battery module 122 and a successor battery module 126. The predecessor battery 122 may have a first-polarity terminal 123 (e.g., a positive terminal or a negative terminal) and a second-polarity terminal 124 opposite the first. The successor battery 126 may also have a first-polarity terminal 123 and a second-polarity terminal 127. The switching units 130 may be operated by means of one or more electric controllers 140. The voltage across the battery pack may be measured with an instrument 142, such as a voltmeter.

In some embodiments, each switching unit 130 may sequentially link its predecessor battery module 122 to its successor battery module 126. The switching unit's relay 132 may link the first-polarity terminal 123 on the predecessor battery module 122 to the first-polarity terminal 127 on the successor battery module 126. When the relay 132 is energized, the first-polarity terminals 123, 127 may be connected electrically. When the relay 132 is open, the first-polarity terminals 123, 127 may be disconnected electrically. Likewise, when all the relays 132 of the battery pack 102 are energized, then the first-polarity terminals of the entire pack 102 of battery modules 110 may be connected to one another electrically, and, when all the relays 132 are open, the first-polarity terminals of the entire pack 102 of battery modules 110 may be disconnected from one another electrically.

In some embodiments, each switching unit 130 also links its predecessor battery module 122 to its successor battery module 126 by means of its SPDT switch 134. The common contact 135 of the switch 134 may be connected electrically to the second-polarity terminal 124 of the predecessor battery module 122; the normally closed contact 136 may be connected to the first-polarity terminal 127 of the successor battery module 126; and the normally open contact 137 may be connected to a second-polarity terminal 128 of the successor battery module 126. When the SPDT switch 134 is in its default position, the second-polarity terminal 124 of the predecessor battery module 122 may be electrically connected to the first-polarity terminal 127 of the successor battery module 126. When the switch 134 is in its actuated position, the second-polarity terminals 124, 128 of the sequential, predecessor-successor battery modules 122, 126 may be connected electrically to one another. Thus, when the entire switching unit 130 is activated, the predecessor battery module 122 may be in parallel with its successor battery module 126, forming a battery module string 112. A string 112 is some number of battery modules 110 connected in parallel. When the entire switching unit 130 is in its default state, the predecessor battery module 122 (and any string 112 of which it is a part) may be in series with its successor battery module 126 (and any string 112 of which it is a part). Likewise, when all the switching units 130 are activated, then all the battery modules 110 of the pack 102 may be connected in parallel, forming a single string 112. When all the switching units 130 are deactivated, then all the battery modules 110 of the pack 102 may be connected in series.

In embodiments, switching units 130 may also be configured so that, when activated, the battery modules 110 are in series and, when deactivated, they are in parallel. The first-polarity terminals 123, 127 may be cathodes or anodes, so long as their polarity is opposite the second-polarity terminals 124, 128.

In embodiments, within each individual switching unit 130, the relay 132 may be opened and the SPDT switch 134 actuated by a single signal from a controller 140. By activating and deactivating switching units 130, battery modules 110 in the pack 102 may be transitioned quickly from series to parallel configurations or from parallel to series. Switching units 130 may be controlled by means of one or more electronic controllers 140. The controllers 140 may activate or deactivate the switching units 130 in response to signals, for example, measurements representing a voltage output across a load 100 or a voltage across the pack 102 as measured by an instrument 142, such as a voltmeter.

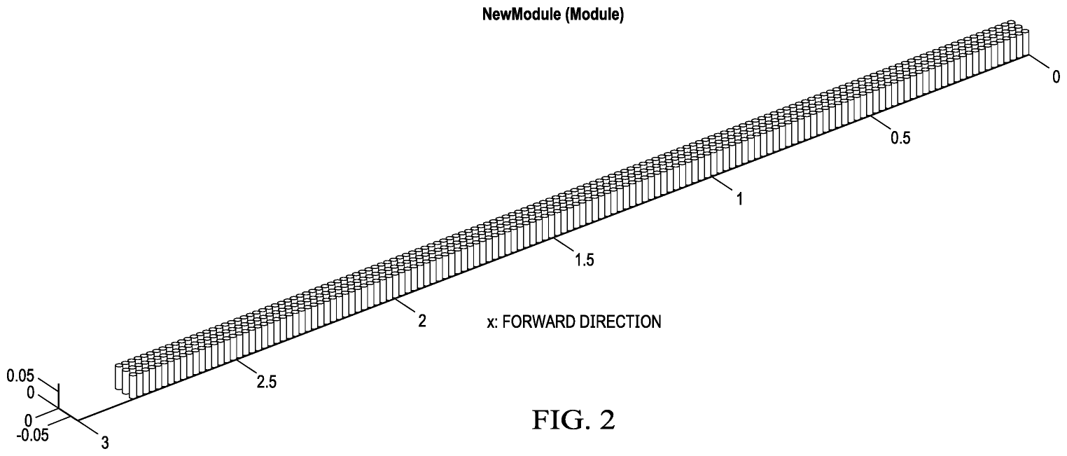

Referring now to FIG. 2, a perspective view of a battery pack is shown. The battery pack 102 may have a plurality of battery modules 110.

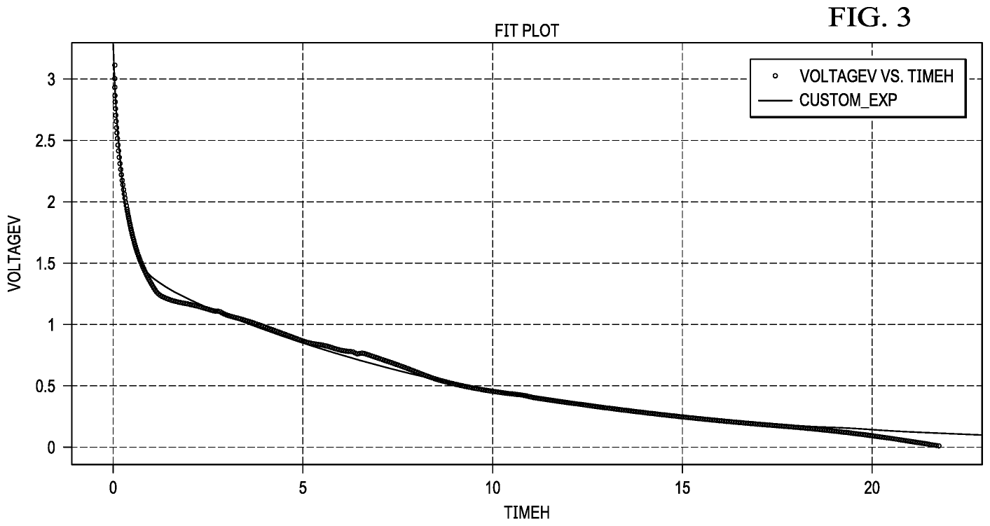

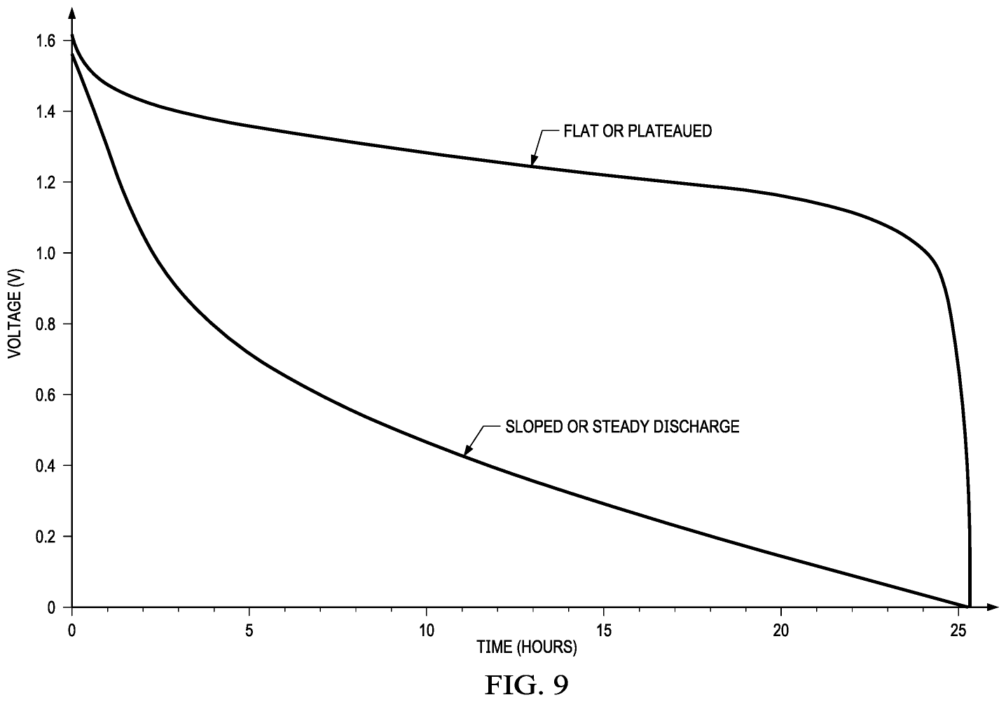

Referring now to FIG. 3, a discharge curve for a battery with a sloped discharge curve is shown. A sloped discharge curve may be distinguished from a discharge curve that is flat or plateaued. With a battery with a flat or plateaued discharge curve, the battery voltage remains substantially constant throughout its discharge cycle, or at least until the battery is near the end of its useable capacity or charge. Stated another way, according to the present disclosure, a battery with a flat or plateaued discharge curve will be one in which the voltage from the battery drops at one rate throughout part of the battery's discharge cycle, and experiences a second, steeper rate of voltage drop through a second or subsequent portion of its discharge. By contrast, a battery with a sloped discharge curve experiences a more or less steady voltage decrease throughout the discharge cycle. See, for example, FIG. 9 illustrating an exemplary sloped discharge curve versus a flat discharge curve. It should also be understood that, while the discharge curves are described with respect to a battery, the case consideration applies to an individual battery cell or any other voltage or current delivery system based on the relevant chemistry producing the flat or sloped discharge curve. In some embodiments, the battery modules 110, and the individual battery cells (not shown) within the modules, may have sloped discharge curves, such as the batteries and devices described in U.S. Pat. No. 9,786,910 to Johnson et al. (hereby incorporated by reference).

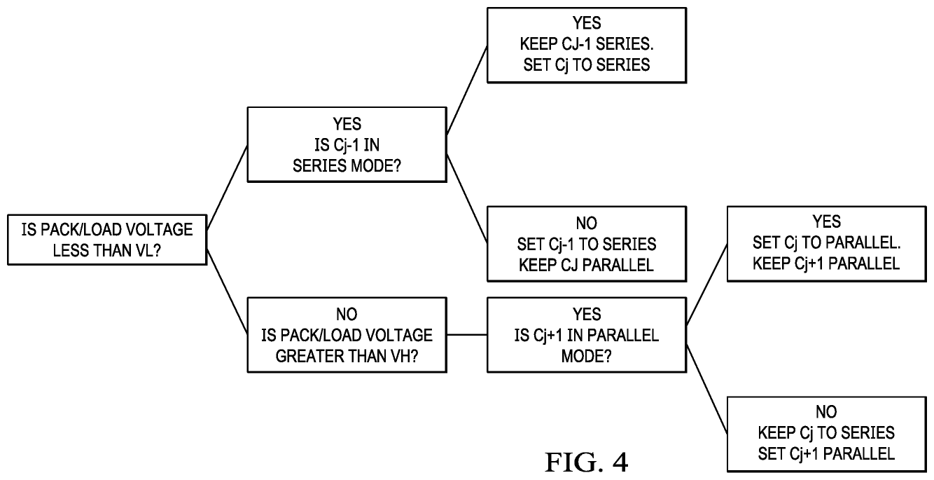

Referring now to FIG. 4, a logic diagram for an embodiment of the system of this disclosure is shown. In embodiments, the controllers 140 may have a machine-readable transitory medium (not shown) with a logic to maintain a voltage range across the battery pack 102 (or the load 100) during discharge. As the battery modules 110 discharge, the voltage across the battery pack 102, V_{P}, may decrease. When the voltage reaches a lower threshold, V_{L}, the controllers 140 may switch the configuration of at least some of the battery modules 110 from parallel to series, increasing the voltage of the pack 102 without charging the individual battery modules 110. In embodiments, the pack 102 is constructed using a plurality of controllers 140 so that, as the individual battery modules 110 decrease in voltage, they are reconfigured in a plurality of steps, each step decreasing the number of battery modules 110 per string 112 and increasing the voltage of the pack 102 by increasing the number of strings 112 in series.

Still referring to FIG. 4, in embodiments, the instrument 142 and controllers 140 may have a machine-readable transitory medium (not shown) with a logic to maintain a voltage range across the battery pack 102 as the battery modules 110 are charged or discharged. As the battery modules 110 are charged, the voltage across the battery pack 102 increases. When the voltage reaches a predetermined upper threshold, V_{H}, the system 104 changes the configuration of at least some of the battery modules 110 from series to parallel, decreasing the voltage of the pack 102 even though the individual battery modules 110 may continue to charge. In some embodiments, the battery management system 104 is constructed using a plurality of controllers 140 so that, as the individual battery modules 110 increase in voltage, they are reconfigured from series to parallel in a plurality of steps, each step decreasing the voltage of the pack 102 by decreasing the number of strings 112 in series and increasing the number of battery modules 110 per string 112. In some embodiments, a single controller 140 may control all the switching units 130.

In embodiments, the invention of this disclosure may be configured such that, in discharging or in charging the battery pack 102, each reconfiguration of battery modules 110 follows a stepwise progression. The reconfigurations may be stepwise in the sense that they follow a sequential and incremental pattern. For example, in some embodiments, each reconfiguration equally divides the battery pack 102 into shorter strings 112, each shorter string 112 having an equal number of battery modules 110 in parallel, and connecting the shorter strings 112 in series. Likewise, when charging, each stepwise reconfiguration may combine battery modules 110 into longer strings 112, each longer string 112 having an equal number of battery modules 110, and the longer strings 112 being electrically connected to one another in series.

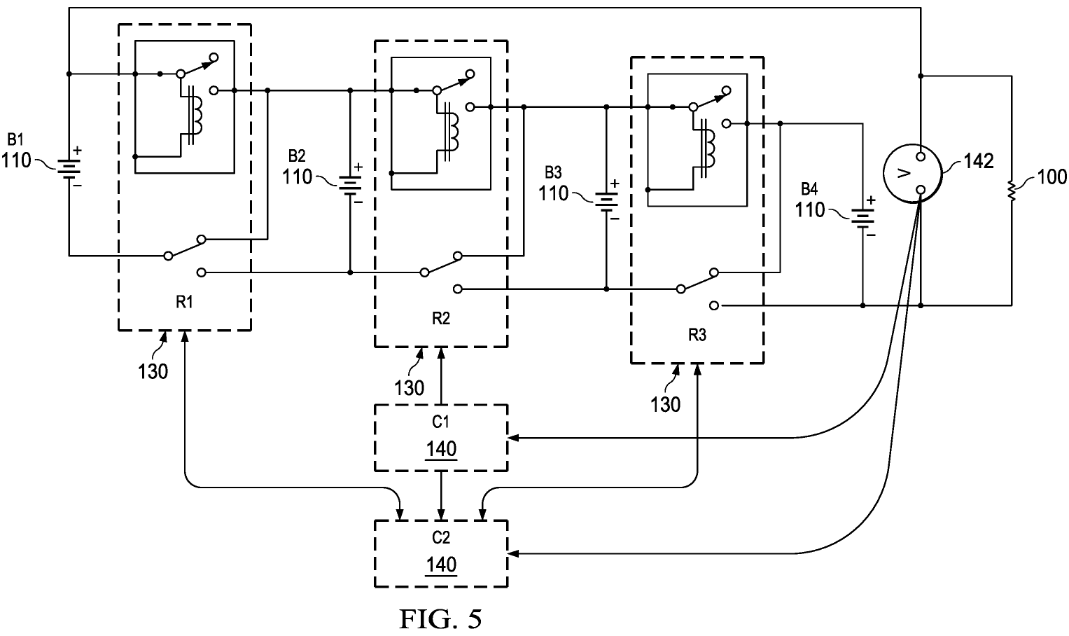

Referring now to FIG. 5, a schematic of a 4-battery pack according to this disclosure is shown. The battery pack 102 may have four battery modules 110, B1, B2, B3, and B4. The embodiment may use three switching units 130, R1, R2, and R3 with switching unit R1 linking B1 to B2; R2 linking B2 to B3; and R3 linking B3 to B4. Two controllers 140, C1 and C2, may be configured such that C1 controls R2, and C2 controls R1 and R3. If the battery pack 102 begins fully charged, then R1, R2, and R3 may begin already-activated by C1 and C2. Thus, B1, B2, B3, and B4 may be in parallel. Once a load 100 is placed across the battery pack 102, the pack 102 may begin to discharge, and its voltage may decrease. Once the voltage across the pack 102 drops below a predetermined lower threshold voltage, V_{L}, C1 may deactivate R2, keeping B1 parallel with B2 and B3 with B4 but bringing the B1-B2 string 112 in series with the B3-B4 string 112, approximately doubling the voltage across the pack 102. The battery modules 110 may continue to discharge, further decreasing their individual voltages and, again, decreasing the voltage of the battery pack 102. Once the voltage across the pack 102 drops below V_{L} a second time, C2 may deactivate R1 and R3, placing B1, B2, B3, and B4 in series and, again, approximately doubling the overall voltage across the pack 102. The pack 102 may continue to supply power to the load until its voltage is depleted beyond a useful level.

Similarly, the embodiment shown in FIG. 5 may be used to maintain the voltage across the battery pack 102 below a predetermined upper threshold, V_{H}, during charging. If the pack 102 is near its lowest capacity, then the battery modules 110 may be in series, and the controllers 140 may be deactivated. The voltage across the pack 102 may increase as capacity is restored to the battery modules 110. When the voltage across the pack 102 reaches the predetermined upper threshold, V_{H}, C2 may activate R1 and R3, placing B1 in parallel with B2 to form a B1-B2 string 112 and B3 in parallel with B4 forming a B3-B4 string 112, thereby approximately halving the voltage across the pack 102. Upon reaching V_{H} a second time, C1 may activate R2, forming a single string 112 from the B1-B2 and B3-B4 strings 112 and, again, approximately halving the voltage of the pack 102. The pack, then, may be charged until fully recharged.

In some embodiments, the number of battery modules 110 in a pack 102 may be selected such that, with each incremental reconfiguration, the battery modules 110 are equally divided or combined into parallel and series combinations, and each stepwise reconfiguration doubles (if increasing the voltage of the pack during discharge) or halves (if decreasing the voltage of the pack during charging) the voltage of the pack 102. In such a system, the number of battery modules 110 in the pack 102, N, may be a power of two (e.g., 2, 4, 8, 16, etc.). The battery modules 110 in the pack 102 may be individually identified as members of a sequence, B₁, B₂, . . . , Bᵢ, . . . , B_{N}, where i is an integer denoting the individual battery's place in the sequence. The number of switching units 130 may be one less than the number of battery modules 110 and identified as R₁, R₂, . . . , Rᵢ, . . . , R_{N-1}. The number of controllers 140 may be the logarithm (base 2) of the number of battery modules 110 (log₂ N) and may be individually identified as C₁, C₂, . . . , Cⱼ, C_{log2 N}, where j is an integer denoting the individual controller. Thus, a sequence of 2 batteries may use 1 switching unit and 1 controller; 4 batteries may use 3 switching units and 2 controllers; 8 batteries may use 7 switching units and 3 controllers; 16 batteries may use 15 switching units and 4 controllers; and so on. In embodiments, controllers 140 may be integrated into a single unit, such as a microprocessor or single-board computer.

The switching units 130 may be linked to the battery modules 110 such that each switching unit 130, Rᵢ, links a predecessor battery 122, B₁, to a successor battery 126, Bᵢ₊₁. So a sequence of battery modules 110 and switching units 130 may be formed in the pattern B₁, R₁, B₂, R₂, B₃, . . . , Bᵢ, R₁, Bᵢ₊₁, B_{N-1}, R_{N-1}, B_{N}.

The controllers 140 may be configured such that, with each stepwise reconfiguration, a controller 140 divides or combines battery modules 110 into equal strings 112. To accomplish this, C₁ may be configured to activate and deactivate R_{N/2}; C₂ may be configured to activate and deactivate R_{N/4} and R_{3N/4}; and so on such that a particular controller Cⱼ controls switching units R_{N/\hat{ }2}, R_{3N/2\hat{ }j}, and so on up to R_{N(1-(1/2\hat{ }j))}. That is, each controller, Cⱼ, may control the switching units {R_{(2k-1)N/2\hat{ }j} |k ∈ N, k≤2^{j-1}}. When discharging, each controller, Cⱼ, may be configured to deactivate (or activate) its switching units 130 only after its predecessor controller, cⱼ₋₁, has deactivated (or activated) its switching units 130. Likewise, when charging, each controller, Cⱼ, may be configured to activate (or deactivate) its relay-switch modules only after its successor controller, has activated its switching units 130.

For example, in a system of 64 battery modules, 6 controllers may be used with 63 switching units. If the controllers are numbered C₁ to C₆, the battery modules Bᵢ to B₆₄, and the switching units R₁ to R₆₃, then controllers may be configured to activate or deactivate the following switching units:

| Cj | R |
|---|---|
| 1 | 32 |
| 2 | 16, 48 |
| 3 | 8, 24, 40, 56 |
| 4 | 4, 12, 20, 28, 36, 44, 52, 60 |
| 5 | 2, 6, 10, 14, 18, 22, 26, 30, 34, 38, 42, 46, 50, 54, 58, 62 |
| 6 | 1, 3, 5, 7, 9, 11, 13, 15, 17, 19, 21, 23, 25, 27, 29, 31, 33, |
| | 35, 37, 39, 41, 43, 45, 47, 49, 51, 53, 55, 57, 59, 61, 63 |

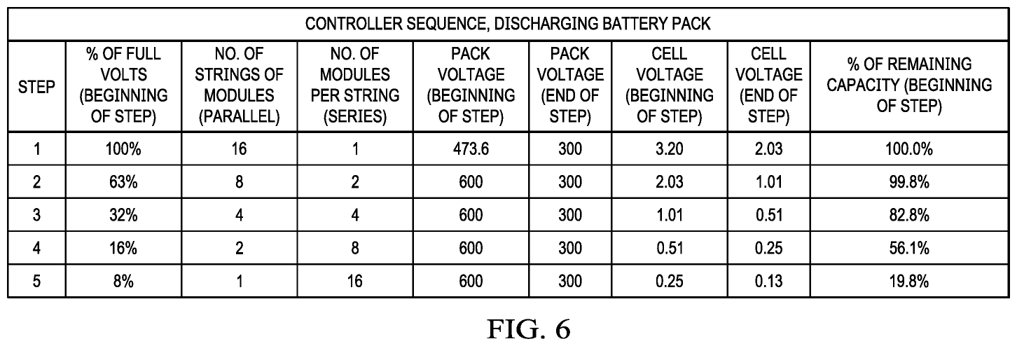

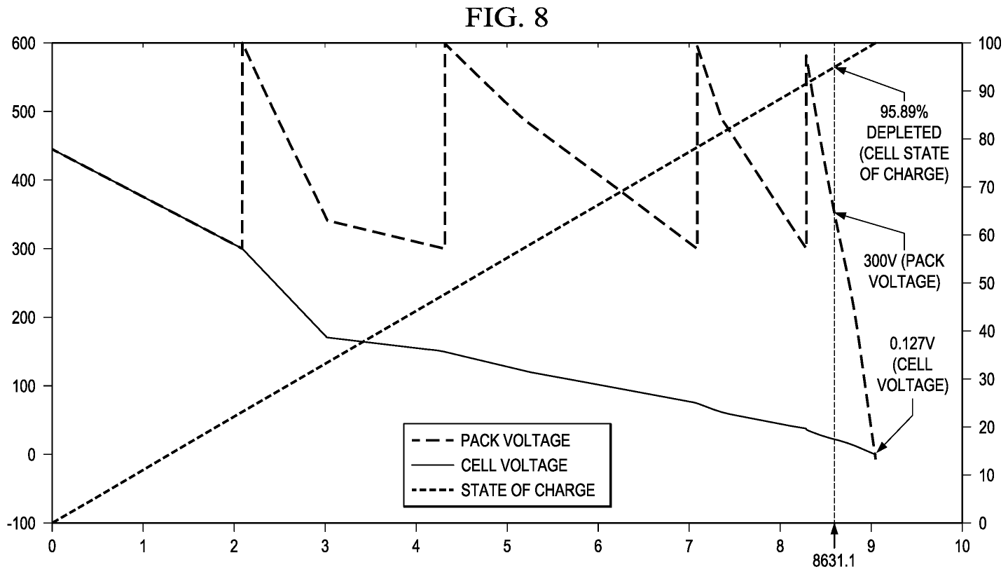

Referring now to FIGS. 6, 7 and 8, tables describing a capacity discharge and a capacity charge of a simulated embodiment of a 4-battery pack with a battery management system, along with a discharge curve of the battery pack, are shown. In the simulation, battery cells with discharge curves like that shown in FIG. 3 were used to construct a battery pack suitable for use in an electric vehicle. In the simulation, Insulated Gate Bipolar Transistors (IGBTs) were used for switching units. The pack had 16 individual battery modules, each battery module having 444 4.7-Ah cells in a 3-parallel-148-series arrangement (for a total of 7,104 cells). As shown in FIGS. 6 and 8, when fully charged with all 16 battery modules in parallel, the battery pack 102 had a beginning voltage of 473.6 V. A stepwise reconfiguration of the battery modules 110 with a predetermined lower threshold voltage, V_{L}, of 300 V maintained the voltage of the entire pack between 600 V and 300 V through a five-step sequence. According to the simulation, once the pack dropped below 300 V at the final step, it had discharged 96% of its total capacity, that is, approximately 85 kWh.

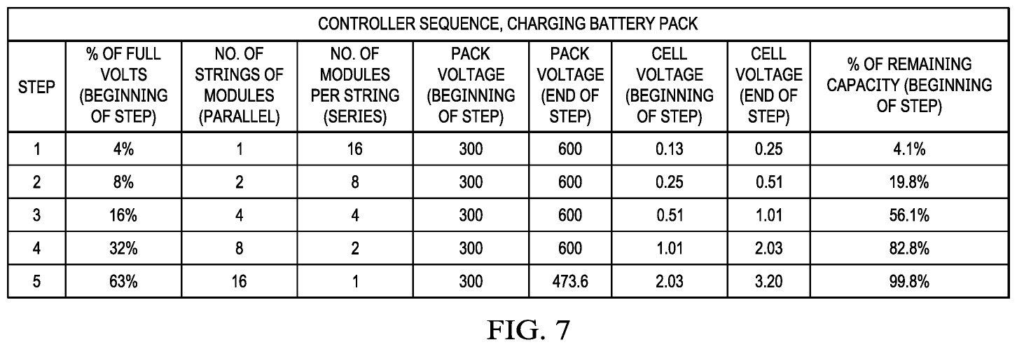

As shown in FIG. 7, the simulated battery pack was recharged through a reverse five-step sequence. When the battery cells were depleted, and the battery modules were in series, the beginning voltage of the pack was 300 V. Charging raised the voltage across the battery cells, but the stepwise reconfiguration of battery modules with a predetermined upper threshold voltage, V_{H}, of 600 V maintained the voltage of the entire pack between 300 V and 600 V. According to the simulation, once the pack reached its final step, and all the battery modules were in parallel, the pack finally reached a voltage of 473.6 V.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)— (a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A battery pack comprising:
a plurality of battery modules;
at least one switching unit adapted to determine a configuration of the battery modules, wherein the switching unit electrically connects one or more battery modules in parallel to form one or more strings, the strings being electrically connected in series;
an instrument adapted to measure a voltage across the battery pack; and
at least one controller adapted to control the at least one switching unit in response to a voltage measurement from the instrument.

2. The battery pack of claim 1, wherein the battery modules have a sloped discharge curve.

3. The battery pack of claim 2, wherein, as the battery modules discharge, the at least one controller and at least one switching unit execute stepwise changes to the configuration of the battery modules to maintain the voltage across the battery pack above a predetermined lower threshold voltage.

4. The battery pack of claim 3, wherein, as the battery modules charge, the at least one controller and at least one switching unit execute stepwise changes to the configuration of the battery modules to maintain the voltage across the battery pack below a predetermined upper threshold voltage.

5. The battery pack of claim 4, wherein, as the battery modules discharge, each stepwise change to the configuration of the battery modules doubles the number of strings electrically connected in series; and wherein, as the battery modules charge, each stepwise change to the configuration of the battery modules divides by two the number of strings electrically connected in series.

6. A control system for managing the voltage across a battery pack, the system comprising:
at least one switching unit adapted to determine a configuration of a plurality of battery modules, wherein one or more battery modules are electrically connected in parallel to form one or more strings, the strings being electrically connected in series;
an instrument adapted to measure a voltage across the battery modules; and
at least one controller adapted to activate or deactivate the at least one switch in response to a voltage measurement from the instrument;
wherein the plurality of battery modules have a sloped discharge curve.

7. The controller of claim 6, wherein, as the battery modules discharge, the at least one controller and the at least one switching unit execute stepwise changes to the configuration of the battery modules to maintain the voltage across the battery pack above a predetermined lower threshold voltage.

8. The controller of claim 7, wherein, as the battery modules discharge, each stepwise change to the configuration of the battery modules doubles the number of strings electrically connected in series.

9. The controller of claim 6, wherein, as the battery modules charge, the at least one controller and the at least one switching unit execute stepwise changes to the configuration of the battery modules to maintain the voltage across the battery pack below a predetermined upper threshold voltage.

10. The controller of claim 9, wherein, as the battery modules charge, each stepwise change to the configuration of the battery modules divides by two the number of strings electrically connected in series.

11. A method for managing a voltage across a plurality of battery modules, the method comprising the steps of:
obtaining a voltage reading from an instrument adapted to measure a voltage across a plurality of battery modules;
comparing the voltage reading to a predetermined lower threshold voltage; and
using at least one controller and at least one switching unit, determining an electrical configuration of the battery modules, wherein one or more battery modules are electrically connected in parallel to form one or more strings, the strings being electrically connected in series.

12. The method of claim 11, wherein, as the battery modules discharge, the at least one controller and the at least one switching unit execute stepwise changes to the configuration of the battery modules to maintain the voltage across the plurality of battery modules above a predetermined lower threshold voltage.

13. The method of claim 12, wherein each stepwise change to the configuration of the battery modules doubles the number of strings electrically connected in series.

14. The method of claim 11, further comprising the step of comparing the voltage reading to a predetermined upper threshold voltage.

15. The method of claim 14, wherein, as the battery modules charge, the at least one controller and the at least one switching unit execute stepwise changes to the configuration of the battery modules to maintain the voltage across the plurality of battery modules below a predetermined upper threshold voltage.

16. The method of claim 11, wherein the battery modules have a sloped discharge curve.
